(19) United States
(12) Patent Application Publication
(10) Pub. No.: US 2023/0042663 A1
(43) Pub. Date: Feb. 9, 2023

(54) Fabric Treatment

(71) Applicant: The Procter & Gamble Company, Cincinnati, OH (US)

(72) Inventors: Nicola Jane BINNEY, Newcastle (GB); Alan Thomas Brooker, Newcastle (GB); Lindsey HEATHCOTE, Northumberland (GB); Libbi MOON, Newcastle (GB); Eva Maria Perez-Prat Vinuesa, Vinhedo (BR); Rachel Morgan Clayton ROEDER, Mason, OH (US)

(21) Appl. No.: 17/851,360

(22) Filed: Jun. 28, 2022

(30) Foreign Application Priority Data
Jun. 30, 2021 (EP) 21182763.9

(51) Int. Cl. D06M 13/256; D06M 13/144

(52) U.S. Cl. CPC D06M 13/256; D06M 13/144

(57) ABSTRACT

A method of treating a fabric, including a treatment step of subjecting the fabric to an aqueous liquor which includes an anionic surfactant and from about 100 ppm to about 7,000 ppm of an acidifying agent wherein the treatment step is not followed by a rinse off step.

### FIELD OF INVENTION

The present invention relates to a method of treating a fabric to provide fabric care benefits and/or bacterial multiplication reduction.

### BACKGROUND OF THE INVENTION

Humidity on fabrics promotes bacterial growth. Bacteria multiply very quickly on humid fabrics in situations commonly found in consumer homes. For example, fabrics dried indoors in regions with hot and humid climates take a long time to dry and the ambient heat and humidity promote bacteria multiplication on the fabrics while they are drying. In other regions, or even for consumers that use a tumble dryer, it is not uncommon to leave the wet clothes inside the washing machine after the laundry process for different period of times before drying them, bacteria remaining on fabrics after the laundry process can easily multiply during the time that the clothes are left wet inside the machine. Under optimal conditions, bacteria can double in number every 20 minutes, if a given garment takes 8 hours to dry, and it has 2 bacteria remaining after the wash process, in the absence of any treatment to prevent bacteria multiplication, at the end of the 8 hours drying process the garment may contain more than 10^6 bacteria.

The object of the present invention is to reduce or prevent bacteria multiplication on fabrics, preferably without using harsh or environmentally unfriendly ingredients and/or to provide fabric care benefits.

### SUMMARY OF THE INVENTION

The present disclosure attempts to solve one or more of the needs above by providing a method of treating a fabric, the method comprises the treatment step of subjecting the fabric to an aqueous liquor. The aqueous liquor comprises an anionic surfactant and from about 100 to about 7,000 ppm, more preferably from 150 to 2000 ppm of an acidifying agent. The method of the invention is free of a rinse step following the treatment step, i.e, the treatment step is not followed by a rinse off step. The method can provide reduction of bacterial multiplication on the fabric during and after the treatment of the fabric. The method can also contribute to malodour reduction, increased freshness, increased yellow under arm stain (aluminum containing) removal, improved fabric feel (softer), colour brightness (encrustation removal), whiteness and less stable suds that contributes to easier rinse ability.

Preferably said liquor has a pH of less than 4.5, more preferably less than 4 and especially from about 1.5 to about 3.8.

The aqueous liquor can be formed by adding to water a composition comprising the surfactant and the acidifying agent, optional antimicrobial active along with further optional adjuncts. The composition can be in liquid or solid form. The aqueous liquor can be the last rinse in a laundry process. Alternative the aqueous liquor can be a ready-to-use composition such as a composition in spray form. The aqueous liquor of the method of the invention does not require antimicrobial actives to reduce bacterial multiplication but it may contain antimicrobial actives to provide further benefits.

### DETAILED DESCRIPTION OF THE INVENTION

As used herein, the articles including “the,” “a” and “an” when used in a claim or in the specification, are understood to mean one or more of what is claimed or described.

As used herein, the terms “include,” “includes” and “including” are meant to be non-limiting.

As used herein, the terms “active” and “agent” are used interchangeably.

The term “substantially free of' or “substantially free from" as used herein refers to either the complete absence of an ingredient or a minimal amount thereof merely as impurity or unintended byproduct of another ingredient. A composition that is “substantially free” of/from a component means that the composition comprises less than about 0.01%, or less than about 0.001%, or even 0%, by weight of the composition, of the component.

All percentages, ratios and proportions used herein are by weight percent of the composition, unless otherwise specified. All average values are calculated “by weight” of the composition, unless otherwise expressly indicated. All ratios are calculated as a weight/weight level, unless otherwise specified.

All measurements are performed at 25° C. unless otherwise specified.

Unless otherwise noted, all component or composition levels are in reference to the active portion of that component or composition, and are exclusive of impurities, for example, residual solvents or by-products, which may be present in commercially available sources of such components or compositions.

### Method

In the method of the invention the fabric is treated by contacting the fabric with an aqueous liquor. The liquor comprises an anionic surfactant and from about 100 ppm to about 7,000 ppm, preferably from about 150 to about 2,000 ppm, more preferably from about 200 to about 1,500 ppm of an acidifying agent. By “aqueous liquor” is herein meant a water based, preferably comprising from about 80% to about 99% by weight of the liquor of water. The liquor is used to treat the fabric. The treatment can take place during the last rinse of a laundry process. The treatment step is more beneficial when is delivered in a rinse that when is delivered in a wash cycle. The rinse can be a stand-alone rinse or it can follow a wash. The treatment step can be part of hand wash or it can take place in a washing machine. If the fabric is treated in a process that involves more than one rinse, the aqueous liquor comprising the anionic surfactant and the acidifying agent are delivered in the final rinse, this contributes to the deposition of acid on the fabric that helps with the reduction of bacterial multiplication during an extended period of time. By “the treatment step not followed by a rinse off step” is herein meant that the fabric is not exposed to another liquor after it has been exposed to the treatment step of the method of the invention.

Preferably, the aqueous liquor of the method of the invention has a pH of less than 4.5, more preferably less than 4 and especially between 1.5 and 3.8.

The fabric is contacted with the aqueous liquor in a contacting step (also referred to herein as a treatment step), that can be part of a typical fabric laundering process. For example, the method of the invention may comprise the steps of (i) in a laundering step, treating a fabric with an aqueous wash liquor; (ii) optionally rinsing the fabric one or two or more times with water; and (iii) in a contacting step, contacting the fabric with the rinse aqueous liquor comprising the anionic surfactant and the acidifying agent. Step (iii) is preferably a rinse step in a hand-washing or machine-washing fabric laundering process. Following the contacting step, the fabric is dried in a drying step (iv).

In the washing/laundering step, generally, an effective amount of a detergent composition is added to water, for example in a conventional washing step, to form the aqueous wash liquor. The aqueous wash liquor so formed is then contacted, typically under agitation, with the fabrics to be laundered. The detergent composition typically comprises a surfactant system and optional cleaning adjuncts. The surfactant system preferably comprises anionic and/or nonionic surfactant.

An effective amount of the detergent composition added to water to form aqueous laundering solutions can comprise amounts sufficient to form from about 500 to 25,000 ppm, or from 500 to 15,000 ppm of composition in aqueous washing solution, or from about 1,000 to 3,000 ppm of the detergent compositions herein will be provided in aqueous washing solution.

Typically, the wash liquor is formed by contacting the detergent with wash water in such an amount so that the concentration of the detergent in the wash liquor is from 0.1 g/l to 5 g/l, or from 1 g/1, and to 4.5 g/l, or to 4.0 g/l, or to 3.5 g/l, or to 3.0 g/l, or to 2.5 g/l, or even to 2.0 g/l, or even to 1.5 g/1.

The wash liquor may comprise 64 litres or less, 40 litres or less of water, or 30 litres or less, or 20 litres or less, or 10 litres or less, or 8 litres or less, or even 6 litres or less of water. Typically, from 0.01 kg to 2 kg of fabric per litre of wash liquor is dosed into said wash liquor. Typically, the wash liquor comprising the detergent has a pH of from 3 to 11.5, typically from 7 to 10.

The laundering step may be followed by one or more optional rinsing steps.

In the treatment step (iii), the fabric is treated with the aqueous liquor, preferably either in a hand washing or in a laundry washing machine rinse step. This step is the final rinse step, immediately before drying the fabric. If desired a fabric softener composition may be added in a rinse step prior to or during the contacting step herein or following the contacting step herein.

Drying of the fabric may be by any conventional means either in domestic or industrial settings: machine drying or open-air drying. The fabric may comprise any fabric capable of being laundered in normal consumer or institutional use conditions, and the invention is suitable for synthetic textiles such as polyester and nylon and natural fabrics comprising cellulosic fibres, and mixed fabrics comprising synthetic and natural fibres, such as polycotton. The water temperature in the contacting step is typically in the range from about 5° C. to about 90° C., though lower water temperatures up to 60 or 40 or 30° C. are useful. The water to fabric ratio is typically from about 1:1 to about 30:1.

Alternatively, the contacting step may be by application of the aqueous liquor directly to the fabric for example by spraying. Ready-to-use compositions may provide more convenience to the user.

The contacting step may be from about 10 seconds to about 20 minutes or from about 15 seconds to about 16 minutes, or from 30 seconds to about 10, or 5, or 3, or 2, or 1 minute.

The method of the invention can provide reduction of bacterial multiplication on the fabric during and after the treatment of the fabric. The method can also contribute to malodour reduction, increased freshness, increase yellow under arm stain (aluminum containing) removal, improved fabric feel (softer), colour brightness (encrustation removal), whiteness and less stable suds that contributes to easier rinse ability. The method of the present invention may deliver improved sanitation of the treated fabric.

### Composition For Use in the Method of the Invention

The composition for use in the method of the invention can be in any suitable form, it can for example be in liquid or solid form, such as powder form. It can be dissolved or diluted to form the aqueous liquor. Alternatively, the composition can be in the form of ready-to-use spray. Surfactant

The aqueous liquor for use in the method of the present disclosure comprises an anionic surfactant and it may comprise additional surfactants. The anionic surfactant can be selected from the group consisting of alkyl sulphate, alkyl alkoxylated sulphate, alkyl benzene sulphonic acid and alkyl benzene sulphonate surfactants; polycarboxylated anionic surfactants and mixtures thereof.

The alkyl sulphate, alkyl alkoxylated sulphate, alkyl benzene sulphonic acid, and alkyl benzene sulphonate surfactants may be linear or branched, substituted or un-substituted. When the surfactant is branched, preferably the surfactant will be a mid-chain branched sulphate or sulphonate surfactant. Preferably the branching groups comprise C1-C4 alkyl groups, typically methyl and/or ethyl groups.

Preferably the composition for use in the method of the invention comprises at least one anionic surfactant selected from the group consisting of C10-C20 linear alkyl benzene sulphonates (LAS), C10-C20 linear alkyl benzene sulphonic acid, C6-C20 linear or branched alkyl sulphate, and C6-C20 linear or branched alkylalkoxy sulfates.

By “linear alkyl sulphate” it is meant herein a non-substituted alkyl sulphate wherein the linear alkyl chain comprises from 6 to 20 carbon atoms, preferably from 8 to 16 carbon atoms, and more preferably from 8 to 14 carbon atoms, and wherein this alkyl chain is sulphated at one terminus.

Typically, the alkyl alkoxylated sulphate has an average degree of alkoxylation of from 0.5 to 30 or 20, or from 0.5 to 10. Preferably the alkoxylating group is an ethoxylating group. Particularly preferred are C8-18 alkyl ethoxylated sulphate having an average degree of ethoxylation of from 0.5 to 10, from 0.5 to 7, from 0.5 to 5 or even from 0.5 to 3.

Suitable linear alkyl benzene sulphonate (LAS) may be obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. A suitable anionic detersive surfactant is alkyl benzene sulphonate that is obtained by DETAL catalyzed process, although other synthesis routes, such as HF, may also be suitable. In one aspect a magnesium salt of LAS is used.

The composition may comprise a polycarboxylated anionic surfactant. Suitable polycarboxylated anionic surfactants are described in US5376298, EP0129328, WO03018733, and US5120326.

Suitable polyalkoxylate polycarboxylated surfactant can have the empirical formula:

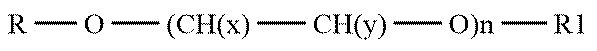

wherein:

R is a hydrophobic group, preferably a substituted, or unsubstituted, hydrocarbon group typically containing from 6 to 16 carbon atoms, preferably from 8 to 14 carbon atoms, x and y are each independently selected from the group consisting of hydrogen, methyl, and succinic acid radicals, with the proviso that at least one x or y moiety per molecule is a succinic acid radical, wherein n is between 1 and 60, and wherein R1 is hydrogen, substituted hydrocarbon, unsubstituted hydrocarbon preferably having between 1 and 8 carbon atoms, sulfuric, or sulfonic radical, with any acid groups being neutralized by compatible cationic groups, e.g., sodium, potassium, alkanolammonium, magnesium, etc.

Suitable polyalkoxylate polycarboxylates surfactant can have the empirical formula:

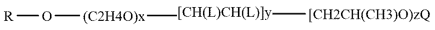

wherein:

R is a hydrocarbon hydrophobic group, preferably alkyl, containing from 6 to 16, preferably from 8 to 14 carbon atoms; x is a number from 0 to 60, preferably from 4 to 50, more preferably from 6 to 50; L is either a C1-3 alkyl group or a group having the formula —CH—(COO—)CH2(COO—), with at least one L group in each molecule being —CH(COO—)CH2(COO—); y is a number from 1 to 12, preferably from 2 to 10, more preferably from 3 to 8; z is a number from 0 to 20, preferably from 0 to 15, more preferably from 0 to 10; and Q is selected from the group consisting of H and sulfonate groups, the compound being rendered electrically neutral by the presence of cationic groups, preferably selected from the group consisting of sodium, potassium, and substituted ammonium, e.g., monoethanol ammonium, cations. Specific examples of such polyalkoxylate polycarboxylate surfactant include the following: Poly-Tergent® C9-51B (CS-1) (x=12; y=8; and Z= 17); Poly-Tergent ® C9-62P (x=4; y=3; and z= 17); Poly-Tergent ® C9-74P (x=10; y=3.5; and Z=3 5.); and Poly-Tergent ® C9-92 (x=approximately 55; y=6.5; and z=0). R is believed to be an alkyl group such as a linear C9 alkyl group, and Q is believed to be H. The Poly-Tergent® surfactants are now sold under the Plurafac® trade name by BASF.

Preferably, the aqueous liquor comprises at least 10 ppm of anionic surfactant. More preferably from 15 to 1000, and especially from 20 to 500 ppm of anionic surfactant. Especially preferred aqueous liquors comprise from 30 to 300 ppm of anionic surfactant, preferably the anionic surfactant is selected from the group consisting of alkyl sulfate, alkyl benzenesulfonic acid and mixtures thereof.

Some of the compositions for use in the method of the invention are generally intended to be diluted prior to use, for example by addition to water in a rinse step of a washing process. In the case of a liquid composition the composition may comprise from about 0.05% to about 5 %, preferably from about 0.5 to about 4% and more preferably from about 1 to about 4% by weight of the composition of anionic surfactant. Preferably, the composition is substantially free of cationic surfactants.

If the composition is in solid form, preferably in powder form, the composition may comprise from about 2 to about 10% by weight of the composition of anionic surfactant, preferably from about 3 to about 8% by weight of the composition of anionic surfactant. Preferably, the composition is substantially free of cationic surfactants.

If the composition is spray form, the composition may comprise from about to 0.001% to about 0.5% by weight of the composition of anionic surfactant, preferably about 0.005% to about 0.4 % and more preferably from about 0.01 to about 0.1 % by weight of the composition of anionic surfactant. Preferably, the composition is substantially free of cationic surfactants.

### Acidifying Agent

The aqueous liquor of the method of the invention comprises at least 100 ppm, more preferably at least 120 ppm, and specially from about 120 to about 3,000 ppm of acidifying agent. The aqueous liquor can be formed by addition of the compositions disclosed herein to water, the composition can be in liquid or solid form. The acidifying agent may help stabilize the pH of the rinse liquor by providing buffering capacity. The acidifying agent may also sequester transition metals, including iron, copper, manganese and the like. The acidifying agent may be chosen to further enhance the antimicrobial activity of the composition. The acidifying agent may be a US EPA/Health Canada registered active or a European notified antimicrobial substance.

Suitable acidifying agents may be selected from the group consisting of organic acids and polymeric acids.

Suitable acidifying agents include C1-C11 organic acids comprising at least one carboxylic acid group, and polymeric acids comprising at least 3 carboxylic acid groups.

Non-limiting examples of C1-C11 organic acids include formic acid, acetic acid, dihydroacetic acid, benzoic acid, malonic acid, citric acid, maleic acid, fumaric acid, succinic acid, lactic acid, malic acid, tartaric acid, gluconic acid, glutaric acid, ascorbic acid, sorbic acid, salicylic acid, adipic acid, 2-ethyl-1-hexanoic acid, heptanoic acid, octanoic acid, nonanoic acid, undecylenic acid, butane tetracarboxylic acid, and the like. The organic acid may be derived from a renewable, plant-based feedstock and produced using natural processes, such as fermentation; examples include bio-based acetic acid, bio-based citric acid, bio-based lactic acid and bio-based succinic acid, and the like. The organic acid may have food-use pedigree or be Generally Regarded As Safe (GRAS) or a food additive by the US Food & Drug Administration.

The organic acid can be selected from the group consisting of: formic acid, acetic acid, malonic acid, citric acid, maleic acid, ascorbic acid, succinic acid, gluconic acid, glutaric acid, lactic acid, salicylic acid, sorbic acid, benzoic acid, itaconic acid, and octanoic acid. Preferably the organic acid is selected from the group consisting of formic acid, citric acid, lactic acid, succinic acid, sorbic acid, acetic acid, salicylic acid, itaconic acid, octanoic acid, malic acid, glycolic acid, benzoic acid and mixtures thereof. Composition comprising citric acid and formic acid have been found to be especially suitable from a bacteriostatic viewpoint. Preferred composition containing citric and formic acid have a citric acid to formic acid weight ratio of 150:1 to 5:1, more preferably 100:1 to 2:1 and even more preferably 50:1 to 3:1.

Non-limiting examples of polymeric acids include polymers of acrylic acid, methacrylic acid, maleic acid, or itaconic acid or copolymers of acrylic acid, methacrylic acid, maleic acid, itaconic acid, or mixtures thereof. Polymeric acids may be homopolymers or copolymers having a molecular weight of 500 g/mol or greater. The polymeric acid may have a molecular weight ranging from 500 g/mol to about 1,000 ,000 g/mol, or from 500 g/mol to 100,000 g/mol, or from about 1,000 g/mol to 20,000 g/mol. Copolymers may be random copolymers or block copolymers. In addition to monomer units comprising carboxylic acid groups, the copolymers may also include one or more other monomers, such as styrene, acrylic ester, acrylamide, olefin sulfonate, and olefin acetate.

The composition may also contain an inorganic acid, suitable inorganic acids include phosphoric acid, sulfuric acid, urea-sulfuric acid, hydrochloric acid, sulfamic acid, methyl sulfuric acid, hypochlorous acid, sodium bisulfate (sodium hydrogen sulfate), and the like.

Preferably the composition in liquid form comprises from 7% to 40%, or from 8% to 35%, or from 9% to 30%, of an organic acid selected from the group consisting of formic acid, citric acid, lactic acid, succinic acid, sorbic acid, acetic acid, salicylic acid, itaconic acid, octanoic acid, malic acid, glycolic acid, benzoic acid and mixtures thereof More preferably the organic acid is selected from the group consisting of formic acid, citric acid, lactic acid, acetic acid and mixtures thereof.

If the composition is in solid form, preferably in powder form, the composition may comprise from about 7 to about 70% by weight of the acidifying agent, preferably from about 10 to about 60% by weight of the composition of acidifying agent. Preferably the acidifying agent comprises citric acid.

If the composition is spray form, the composition may comprise from about to 0.009% to about 5% by weight of the composition of acidifying agent, preferably about 0.1% to about 4.5 % by weight of the composition of acidifying agent.

An increased concentration of acidifying agent increases the composition’s reserve buffering capacity, which reduces pH fluctuation upon dilution.

The weight ratio of organic acid to anionic surfactant in the composition may be from about 1350:1 to 1:1, more preferably from about 875:1 to 1.3:1, even more preferably from about 600:1 to 2:1.

### Optional Ingredients

### Additional Antimicrobial Agent

The composition of the method of the present invention may comprise additional antimicrobial agents or it may be free of additional antimicrobial agents.

### Additional Surfactant

The composition may comprise an additional surfactant, preferably a non-ionic, or a zwitterionic surfactant.

Suitable non-ionic surfactants include alkyl polyglucoside and/or alkyl alkoxylated alcohols.

Alkyl polyglycosides are biodegradable nonionic surfactants. Suitable alkyl polyglycosides can have the general formula CnH2n+10(C6H1005)xH wherein n is preferably from 8 to 16, more preferably 8 to 14, and x is at least 1. Examples of suitable alkyl polyglucoside surfactants are the TRITON™ alkyl polyglucosides from Dow; Agnique PG, Disponil APG and Glucopon alkyl polyglucosides from BASF. Preferred alkyl polyglucoside surfactants are those where n is 8 to 12, more preferably 8 to 10, such as for example Triton CG50 (Dow).

Suitable alcohol alkoxylated nonionic surfactants are according to the formula RO—(A)nH, wherein: R is a primary C4 to C18, preferably a C6 to C16, more preferably a C6 to C14 branched or linear alkyl chain, or a C6 to C28 alkyl benzene chain; A is an ethoxy or propoxy or butoxy unit, or mixtures thereof, and wherein n is from 1 to 30, preferably from 1 to 15, more preferably from 3 to 12 even more preferably from 3 to 8. Preferred R chains for use herein are the C6 to C16 linear or branched alkyl chains.

In one aspect, the alkyl alkoxylated alcohol may be a C8-18 alkyl ethoxylated alcohol having an average degree of ethoxylation of from 1 to 10, from 1 to 7, more from 1 to 5 or from 3 to 7, or even below 3 or 2. The alkyl alkoxylated alcohol can be linear or branched, and substituted or un-substituted.

Suitable branched alkoxylated alcohol may be selected from the group consisting of: C4-C10 alkyl branched alkoxylated alcohols, and mixtures thereof. The branched alkoxylated alcohol can be derived from the alkoxylation of C4-C10 alkyl branched alcohols selected form the group consisting of: C4-C10 primary mono-alcohols having one or more C1-C4 branching groups.

By C4-C10 primary mono-alcohol, it is meant that the main chain of the primary mono-alcohol has a total of from 4 to 10 carbon atoms. The C4-C10 primary mono-alcohol can be selected from the group consisting of: methyl butanol, ethyl butanol, methyl pentanol, ethyl pentanol, methyl hexanol, ethyl hexanol, propyl hexanol, dimethyl hexanol, trimethyl hexanol, methyl heptanol, ethyl heptanol, propyl heptanol, dimethyl heptanol, trimethyl heptanol, methyl octanol, ethyl octanol, propyl octanol, butyl octanol, dimethyl octanol, trimethyl octanol, methyl nonanol, ethyl nonanol, propyl nonanol, butyl nonanol, dimethyl nonanol, trimethyl nonanol and mixtures thereof.

The C4-C10 primary mono-alcohol can be selected from the group consisting of: ethyl hexanol, propyl hexanol, ethyl heptanol, propyl heptanol, ethyl octanol, propyl octanol, butyl octanol, ethyl nonanol, propyl nonanol, butyl nonanol, and mixtures thereof.

Preferably the C4-C10 primary mono-alcohol is selected from the group consisting of: ethyl hexanol, propyl hexanol, ethyl heptanol, propyl heptanol, and mixtures thereof.

The C4-C10 primary mono-alcohol is most preferably ethyl hexanol, and propyl heptanol. In the branched alkoxylated alcohol, the one or more C1-C4 branching group can be substituted into the C4-C10 primary mono-alcohol at a C 1 to C3 position, preferably at the C 1 to C2 position, more preferably at the C2 position, as measured from the hydroxyl group of the starting alcohol. The branched alkoxylated alcohol can comprise from 1 to 14, preferably from 2 to 7, more preferably from 4 to 6 ethoxylate units, and optionally from 1 to 9, preferably from 2 to 7, more preferably from 4 to 6 of propoxylate units.

The branched alkoxylated alcohol is preferably 2-ethyl hexan-1-ol ethoxylated to a degree of from 4 to 6, and propoxylated to a degree of from 4 to 6, more preferably, the alcohol is first propoxylated and then ethoxylated. Another preferred branched alkoxylated alcohols are 2-alkyl-1-alkanols such as alkoxylated C10 guerbet alcohols with 1 to 14, preferably from 2 to 7, more preferably from 3 to 6 ethoxylate or ethoxylate-propoxylate units.

Non-limiting examples of suitable branched alkoxylated alcohols are, for instance, Ecosurf® EH3, EH6, and EH9, commercially available from DOW, and Lutensol® XP alkoxylated Guerbet alcohols & Lutensol® XL ethoxylated Guerbet alcohols available from BASF.

Suitable amphoteric/zwitterionic surfactants include amine oxides and betaines.

Suitable amine oxide surfactants include: R1R2R3NO wherein each of R1, R2 and R3 is independently a saturated or unsaturated, substituted or unsubstituted, linear or branched hydrocarbon chain having from 1 to 30 carbon atoms. Preferred amine oxide surfactants are amine oxides having the following formula: RIR2R3NO wherein R1 is a hydrocarbon chain comprising from 1 to 30 carbon atoms, preferably from 6 to 20, more preferably from 8 to 16 and wherein R2 and R3 are independently saturated or unsaturated, substituted or unsubstituted, linear or branched hydrocarbon chains comprising from 1 to 4 carbon atoms, preferably from 1 to 3 carbon atoms, and more preferably are methyl groups. R1 may be a saturated or unsaturated, substituted or unsubstituted linear or branched hydrocarbon chain.

Suitable betaines are alkyl betaines, alkylamidobetaine, amidazoliniumbetaine, sulfobetaine (INCI Sultaines) as well as the phosphobetaine.

Suitable betaines are the alkyl betaines of the formula (Ia), the alkyl amido betaine of the formula (Ib), the sulfo betaines of the formula (Ic) and the amido sulfobetaine of the formula (Id);

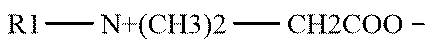

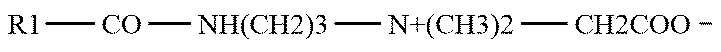

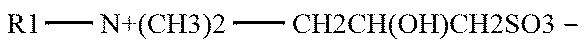

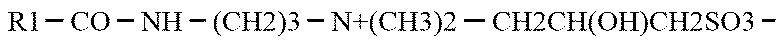

in which R1 is a saturated or unsaturated C6-C22 alkyl residue, preferably C8-C18 alkyl residue.

### Complexing or Chelating Agent

The composition to be used in the method of the present invention may comprise a complexing or chelating agent. Without wishing to be bound by the theory, it is known that complexing or chelating agents may enhance the susceptibility of gram- bacteria to antimicrobial actives by enhancing the permeability of their outer membrane to those actives. In addition, complexing agents may decrease the amount of free hardness in the water used in the method of the present invention. Anionic alkyl sulphate and alkyl benzene sulphonate surfactants are more effective at low water hardness as they tend to precipitate as calcium soaps in high hardness environments.

Suitable complexing or chelating agents include copper, iron and/or manganese chelating agents and mixtures thereof. Suitable molecules include aminocarboxylates, aminophosphonates, succinates, polyitaconic acid, salts thereof, and mixtures thereof. Non-limiting examples of suitable chelants for use herein include ethylenediaminetetracetates, N-(hydroxyethyl)ethylenediaminetriacetates, nitrilotriacetates, ethylenediamine tetraproprionates, triethylenetetraaminehexacetates, diethylenetriamine-pentaacetates, ethanoldiglycines, ethylenediaminetetrakis (methylenephosphonates), diethylenetriamine penta(methylene phosphonic acid) (DTPMP), ethylenediamine disuccinate (EDDS), hydroxyethanedimethylenephosphonic acid (HEDP), methylglycinediacetic acid (MGDA), diethylenetriaminepentaacetic acid (DTPA), salts thereof, and mixtures thereof. Other nonlimiting examples of chelants of use in the present invention are found in U.S. Pat. Nos. 7,445,644, 7,585,376 and 2009/0176684A1. Other suitable chelating agents for use herein are the commercial DEQUEST series, and chelants from Monsanto, DuPont, and Nalco, Inc.

### Suds Suppressor

Compounds for reducing or suppressing the formation of suds may be incorporated into the compositions to be used in the method of the present invention. A wide variety of materials may be used as suds suppressors, and suds suppressors are well known to those skilled in the art. See, for example, Kirk Othmer Encyclopedia of Chemical Technology, Third Edition, Volume 7, pages 430-447 (John Wiley & Sons, Inc., 1979). Examples of suds supressors include monocarboxylic fatty acid and soluble salts therein, high molecular weight hydrocarbons such as paraffin, fatty acid esters (e.g., fatty acid triglycerides), fatty acid esters of monovalent alcohols, aliphatic C18-C40 ketones (e.g., stearone), N-alkylated amino triazines, waxy hydrocarbons preferably having a melting point below about 100° C., silicone suds suppressors, and secondary alcohols. Suds supressors are described in U.S. Pat. Nos. 2,954,347; 4,265,779; 4,265,779; 3,455,839; 3,933,672; 4,652,392; 4,978,471; 4,983,316; 5,288,431; 4,639,489; 4,749,740; and U.S. Pat. Nos. 4,798,679; 4,075,118; European Patent Application No. 89307851.9; EP 150,872; and DOS 2,124,526.

For any compositions to be used in automatic laundry washing machines, suds should not form to the extent that they overflow the washing machine. For compositions used in the rinse cycle, it is highly preferred not to have any suds as users judge the efficacy of the rinse by the absence of visible suds. Suds suppressors, when utilized, are preferably present in a “suds suppressing amount. By “suds suppressing amount” is meant that the formulator of the composition can select an amount of this suds controlling agent that will prevent the composition from forming visible suds when used in a rinse cycle. The compositions herein will generally comprise from 0% to 10% of suds suppressor. When utilized as suds suppressors, monocarboxylic fatty acids, and salts therein, will be present typically in amounts up to 5%, by weight, of the composition. Preferably, from 0.5% to 3% of fatty monocarboxylate suds suppressor is utilized. Silicone suds suppressors are typically utilized in amounts up to 2.0%, by weight of the composition, although higher amounts may be used. Monostearyl phosphate suds suppressors are generally utilized in amounts ranging from 0.1% to 2%, by weight of the composition. Hydrocarbon suds suppressors are typically utilized in amounts ranging from 0.01% to 5.0%, although higher levels can be used. The alcohol suds suppressors are typically used at 0.2%-3% by weight of the finished compositions.

### Dispersants

The composition may preferably also contain dispersants. Suitable water-soluble organic materials include the homo- or co-polymeric acids or their salts, in which the polycarboxylic acid comprises at least two carboxyl radicals separated from each other by not more than two carbon atoms.

### Hydrotropes

The composition may also contain hydrotropes to enhance the solubility of sparingly soluble organic molecules and increase the stability of the composition. Particularly preferred hydrotropes are methyl, dimethyl and methylethyl benzene sulfonates, particularly sodium cumene sulfonate, sodium xylene sulfonate and sodium toluene sulfonate.

### Fabric Shading Dye

The composition to be used in the method of the present invention may comprise fabric shading dye. Suitable fabric shading dye (sometimes referred to as hueing, bluing or whitening agents) typically provides a blue or violet shade to fabric. Fabric shading dyes can be used either alone or in combination to create a specific shade of hueing and/or to shade different fabric types. This may be provided for example by mixing a red and green-blue dye to yield a blue or violet shade. The fabric shading dye may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof.

Suitable fabric shading dyes include dyes and dye-clay conjugates. Preferred fabric shading dyes are selected from small molecule dyes and polymeric dyes. Suitable small molecule dyes include small molecule dyes selected from the group consisting of dyes falling into the Colour Index (C.I.) classifications of Acid, Direct, Basic, Reactive, Solvent or Disperse dyes for example that are classified as Blue, Violet, Red, Green or Black, and provide the desired shade either alone or in combination with other dyes or in combination with other adjunct ingredients. Dyes described as hydrolysed Reactive dyes, as described in EP-A-1794274 may also be included. In another aspect, suitable small molecule dyes include small molecule dyes selected from the group consisting of Colour Index (Society of Dyers and Colourists, Bradford, UK) numbers Direct Violet dyes such as 5, 7, 9, 11, 31, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 48, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in US 2008/034511 A1 or U.S. Pat. No. 8,268,016 B2 , or dyes as disclosed in U.S. Pat. No. 7,208,459 B2 , such as solvent violet 13 and mixtures thereof. In another aspect, suitable small molecule dyes include small molecule dyes selected from the group consisting of C. I. numbers Acid Violet 17, Acid Blue 80, Acid Violet 50, Direct Blue 71, Direct Violet 51, Direct Blue 1, Acid Red 88, Acid Red 150, Acid Blue 29, Acid Blue 113 or mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, US 2012/225803 A1, US 2012/090102 A1, WO2012/166768, U.S. Pat. No. 7,686,892 B2, and WO2010/142503.

Other suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet Conn., carboxymethyl cellulose (CMC) covalently bound to one or more reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, alkoxylated carbocyclic and alkoxylated heterocyclic azo colourants, and mixtures thereof. Preferred polymeric dyes comprise the optionally substituted alkoxylated dyes, such as alkoxylated triphenyl-methane polymeric colourants, alkoxylated thiophene polymeric colourants, alkoxylated carbocyclic and alkoxylated heterocyclic azo colourants, and mixtures thereof, such as the Liquitint dyes.

Preferred hueing dyes include the whitening agents found in WO 08/87497 A1, WO2011/011799 and US 2012/129752 A1. Preferred hueing agents for use in the present invention may be the preferred dyes disclosed in these references, including those selected from Examples 1-42 in Table 5 of WO2011/011799. Other preferred dyes are disclosed in U.S. Pat. No. 8,138,222. Other preferred dyes are disclosed in U.S. Pat. No. 7,909,890 B2.

### Optical Brighteners

The composition to be used in the method of the present invention may comprise one or more optical brighteners. Suitable examples of optical brighteners are for example stilbene brighteners, coumarinic brighteners, benzoxazole brighteners and mixtures thereof. Diaminostilbene disulphonic acid type brighteners (hereinafter referred to as “DAS”) are classified as hydrophilic in WO-A-98/52907. A commercial example of a DAS is Tinopal DMS (ex CIBA). Another type of low ClogP brightener is a distyrylbiphenyl brightener (hereinafter referred to as “DSBP”). A commercial example of this type of brightener is Tinopal CBS-X (also ex CIBA). Commercial optical brighteners which may be useful in the present invention can be classified into subgroups, which include, but are not limited to, derivatives of stilbene, pyrazoline, carboxylic acid, methinecyanines, dibenzothiophene-5,5-dioxide, azoles, 5- and 6-membered-ring heterocycles, and other miscellaneous agents. Particularly preferred brighteners are selected from: sodium 2 (4-styryl-3-sulfophenyl)-2H-naphtho [1,2-d] triazole, disodium 4,4'-bis([4-anilino-6-(N-methyl-2-hydroxyethylamino)-1,3,5-triazin-2-yl]amino)stilbene-2,2'-disulfonate, disodium 4,4'-bis[(4-anilino-6-morpholino-1,3,5-triazin-2-yl)amino]stilbene-2,2'-disulfonate, and disodium 4,4'-bis(2-sulfostyryl)biphenyl. Other examples of such brighteners are disclosed in “The Production and Application of Fluorescent Brightening Agents”, M. Zahradnik, Published by John Wiley & Sons, New York (1982).

### Aesthetic Dyes

The composition to be used in the method of the present invention may comprise aesthetic dyes and/or pigments. Suitable dyes include any conventional dye, typically small molecule or polymeric, used for colouring cleaning and/or treatment compositions. These are generally non-fabric shading dyes.

### Solvent System

The present compositions may comprise a solvent system for example comprising water alone or mixtures of organic solvents. Preferred organic solvents include 1,2-propanediol, ethanol, glycerol, dipropylene glycol, methyl propane diol and mixtures thereof. Other lower alcohols, C1-C4 alkanolamines such as monoethanolamine and triethanolamine, can also be used. Solvent systems are more typically present at levels in the range of from about 0.1% to about 98%, preferably at least about 1% to about 50%, more usually from about 5% to about 25% by weight of the liquid composition.

### Thickener/ Structurant

In some embodiments of the invention, the composition to be used in the method of the present invention is in the form of a structured liquid. Such structured liquids can either be internally structured, whereby the structure is formed by primary ingredients (e.g. surfactant material) and/or externally structured by providing a three dimensional matrix structure using secondary ingredients (e.g. polymers, clay and/or silicate material), for use e.g. as thickeners. The composition may comprise a structurant, preferably from 0.01 wt % to 5 wt %, from 0.1 wt % to 2.0 wt % structurant. Examples of suitable structurants are given in US2006/0205631A1, US2005/0203213A1, U.S. Pat. Nos. 7,294,611, 6,855,680. The structurant is typically selected from the group consisting of diglycerides and triglycerides, ethylene glycol distearate, microcrystalline cellulose, cellulose-based materials, microfiber cellulose, ally modified alkali-swellable emulsions such as Polygel W30 (3VSigma), biopolymers, xanthan gum, gellan gum, hydrogenated castor oil, derivatives of hydrogenated castor oil such as non-ethoxylated derivatieves thereof and mixtures thereof, in particular, those selected from the group of hydrogenated castor oil, derivatives of hydrogenated castor oil, microfibullar cellulose, hydroxyfunctional crystalline materials, long chain fatty alcohols, 12-hydroxystearic acids, clays and mixtures thereof. A preferred structurant is described in. U.S. Pat. No. 6,855,680 which defines suitable hydroxyfunctional crystalline materials in detail. Preferred is hydrogenated castor oil.

### Soil Release Polymers

The composition to be used in the method of the present invention may comprise soil release polymers. Suitable soil release polymers are polyester soil release polymers such as Repel-o-tex polymers, including Repel-o-tex SF, SF-2 and SRP6 supplied by Rhodia. Other suitable soil release polymers include Texcare polymers, including Texcare SRA100, SRA300, SRN100, SRN170, SRN240, SRN300 and SRN325 supplied by Clamant. Other suitable soil release polymers are Marloquest polymers, such as Marloquest SL supplied by Sasol.

### Dye Transfer Inhibitor (DTI)

The present compositions may comprise dye transfer inhibiting agents. Suitable dye transfer inhibitors are selected from the group consisting of: polyvinylpyrrolidone polymers, polyamine N-oxide polymers, copolymers of N-vinylpyrrolidone and N-vinylimidazole, polyvinyloxazolidones, polyvinylimidazoles and mixtures thereof. Other suitable DTIs are triazines as described in WO2012/095354, polymerized benzoxazines as described in WO2010/130624, polyvinyl tetrazoles as described in DE 102009001144A, porous polyamide particles as described in WO2009/127587 and insoluble polymer particles as described in WO2009/124908. Other suitable DTIs are described in WO2012/004134, or polymers selected from the group consisting of (a) amphiphilic alkoxylated polyamines, amphiphilic graft copolymers, zwitterionic soil suspension polymers, manganese phthalocyanines, peroxidases and mixtures thereof. Preferred classes of DTI include but are not limited to polyvinylpyrrolidone polymers, polyamine N-oxide polymers, copolymers of N-vinylpyrrolidone and N-vinylimidazole, polyvinyloxazolidones, polyvinylimidazoles and mixtures thereof.

### Encapsulates

The composition to be used in the method of the present invention may comprise an encapsulate, for example an encapsulate comprising a core, and a shell having an inner and outer surface, said shell encapsulating said core. The core may comprise any laundry care adjunct, preferably a perfume. The shell may comprise a material selected from the group consisting of polyethylenes; polyamides; polyvinylalcohols; polystyrenes; polyisoprenes; polycarbonates; polyesters; polyacrylates; aminoplasts, in one aspect said aminoplast may comprise a polyureas, polyurethane, and/or polyureaurethane, in one aspect said polyurea may comprise polyoxymethyleneurea and/or melamine formaldehyde; polyolefins; polysaccharides, in one aspect said polysaccharide may comprise alginate and/or chitosan; gelatin; shellac; epoxy resins; vinyl polymers; water insoluble inorganics; silicone; and mixtures thereof. In a preferred aspect the composition may comprise a deposition aid, preferably in addition to encapsulates. Preferred deposition aids are selected from the group consisting of cationic and nonionic polymers. Suitable polymers include cationic starches, cationic hydroxyethylcellulose, polyvinylformaldehyde, locust bean gum, mannans, xyloglucans, tamarind gum, polyethyleneterephthalate and polymers containing dimethylaminoethyl methacrylate, optionally with one or more monomers selected from the group comprising acrylic acid and acrylamide.

### Perfume

Preferred compositions to be used in the method of the presence invention comprise a perfume, preferably in the range from 0.001 to 3 wt %, most preferably from 0.1 to 1 wt %. Many suitable examples of perfumes are provided in the CTFA (Cosmetic, Toiletry and Fragrance Association) 1992 International Buyers Guide, published by CFTA Publications and OPD 1993 Chemicals Buyers Directory 80th Annual Edition, published by Schnell Publishing Co. It is usual for a plurality of perfume components to be present in the compositions of the invention.

### pH Modifying Agents

pH modifiers may be incorporated to generate the desired pH.

The pH of the composition to be used in the method of the present invention is preferably below 4.5, more preferably below 4, even more preferably between 1.5 and 3.8. Alkali or acid known to those skilled in the art of laundry product manufacturing may be added, for example, sodium or potassium hydroxide, carbonate or silicate, or acids such as hydrochloric acid. Those pH modifiers which add buffering capacity may be particularly preferred.

### Pearlescent Agents

Pearlescent agents as described in WO2011/163457 may be incorporated into the present compositions.

A preferred liquid composition for use in the method of the invention comprises:
a) from about 0.05 to about 4.5% by weight of the composition of an anionic surfactant selected from the group consisting of alkyl sulphate, alkyl benzene sulphonic acid and mixtures thereof; and
b) at least 7%, preferably from about 8 to about 35%, more preferably from about 9 to about 30% by weight of the composition of an organic acid selected from the group consisting of: formic acid, citric acid, lactic acid, succinic acid, sorbic acid, acetic acid, salicylic acid, octanoic acid, malic acid, glycolic acid, benzoic acid, itaconic acid and mixtures thereof preferably the organic acid comprises a mixture of citric acid and formic acid.

A preferred solid composition for use in the method of the invention comprises:
a) from about 2 to about 10% by weight of the composition of an anionic surfactant, preferably selected from the group consisting of alkyl sulphate, alkyl ethoxy sulphate, alkyl benzene sulphonate, alkyl benzene sulphonic acid and mixtures thereof;
b) at least 7%, preferably from about 8 to about 70%, more preferably from 9 to 65 % by weight of the composition, of citric acid.

A preferred composition in the form of a ready-to-use composition comprises:
a) from about 0.001% to about 0.1% by weight of the composition of an anionic surfactant, preferably selected from the group consisting of alkyl sulphate, alkyl ethoxy sulphate, alkyl benzene sulphonate, alkyl benzene sulphonic acid and mixtures thereof; and
b) at least 0.01%, preferably from about 0.015% to about 0.7%, more preferably from about 0.1% to about 0.6% by weight of the composition, of an acidifying agent selected from the group consisting of formic acid, citric acid, lactic acid, succinic acid, sorbic acid, acetic acid, salicylic acid, octanoic acid, malic acid, glycolic acid, benzoic acid, itaconic acid and mixtures thereof, preferably the acidifying agent comprises citric acid.

### EXAMPLES

### Example 1

### Bacteria Preparation

Frozen glycerol bacterial stock was plated on a tryptone soy agar plate (TSA) using an inoculating loop, after 24h incubation at 32-35° C., an additional pass to a new TSA plate was performed before making a working bacteria suspension to test bacteriostatic efficacy of the compositions used in the method of the present invention.

A working bacteria suspension was prepared by transferring several colonies from the agar plate to a sterile saline solution (0.85% NaC1). Bacteria concentration was adjusted to 10^8 CFU/ml by measuring OD at 425 nm using a spectrophotometer. This bacteria suspension was further diluted to 10^5 CFU/ml using Tryptone Soy Broth (TSB). For the samples tested under extra-soiled conditions, the bacteria suspension was supplemented with 5% horse serum.

### Fabric Preparation/Pre-Treat

Cotton fabric swatches were scoured and sterilized as described in the Standard Test Method for the Evaluation of Laundry Sanitizers and Disinfectants ASTM E2274.

Three test swatches were combined with fabric ballast to make up a bundle of 1.69 g fabrics per test leg, 30 ml solutions of each test sample were prepared at the indicated concentrations and water hardness and added to 50 ml centrifuge tubes, the prepared 1.69 g fabric bundles were added to the centrifuge tubes and the tubes placed in a Stuart Rotator and agitated at 40 rpm for the indicated time mimicking the duration of a rinse cycle.

Treated test fabrics were transferred with a sterile tweezer to the wells of a sterile 12 well microtiter plate and let dry for approximately 1 hour. Once dried, each test fabric was inoculated with 20 µL of the bacteria suspension prepared as described above. Inoculated test fabrics were incubated for 18-24 h at 32° C. and constant humidity. Three fabrics were prepared for each test leg. Reference fabrics were treated with water of the same hardness as the test samples following the same protocol.

### Determination of Germ Growth Prevention Efficacy

Test and reference swatches, three per each test and reference sample, were transferred to vials containing 10 ml of neutralizer (Letheen Broth) and each vial was vortexed at high speed for 30 seconds to extract the bacteria from the fabrics. 1: 10 serial dilutions were prepared in neutralizer and 100 µL of each dilution were plated on 55 mm TSA plates by spreading thoroughly across the plate using a sterile spreader. Plates were incubated for 18-24h at 32° C.

Germ growth prevention efficacy was determined by subtracting the number of bacteria extracted from the test samples to the number of bacteria extracted from the reference samples. Bacteria numbers were determined by counting the CFU extracted from the test and reference samples. The total CFU present in test and reference swatches was calculated by multiplying the counted CFU present in each plate by the dilution of the solution plated and converting this number to logarithmic scale.

### Bacteriostatic Efficacy = LogCFUreference-LogCFUTest

The formulations showed in TABLE 1 below were prepared and their antibacterial efficacy tested as described in above method which follows the guidance of the JIS 1902 “testing for antibacterial activity and efficacy on textile products”.

The compositions were diluted to the indicated concentration prior to testing in the method of the present invention. Fabrics were treated with the diluted compositions for the indicated times. Fabrics were not rinsed after the treatment with the compositions. After the treatment, fabrics were inoculated with the bacteria Salmonella enterica ATCC 10708, Staphylococcus aureus ATCC 6538, or Klebsiella pneumoniae ATCC 13883 at 10^5 CFU/ml prepared in Tryptone Soy Broth and incubated for 18-24 h. Reference fabrics were prepared in the same way but treated with water. Log reduction was measured vs reference fabrics by extracting the bacteria from the fabrics in Letheen Broth. Live bacteria were quantified by diluting, plating and colony counting following standard microbiology techniques.

All Ingredients in the compositions are in % weight active.

Table 1

COMPOSITIONS TESTED

| Ingredients (% active) | A | B | C | D | E | F | G | H | I | C.1 | C.2 | C.3 |
|---|---|---|---|---|---|---|---|---|---|---|---|---|
| Acetic acid | 0.5 | 0.8 | 0.75 | 0.75 | 0.5 | 1 | 1 | 6 | 0.5 | | | 0.4 |
| Formic acid | | | | | | | | | 0.1 | | | |
| Citric acid | | 10 | 10 | 15 | 9 | 7.5 | 23 | | | 20 | 6 | |
| Lactic acid | | | | | | | | 15 | 6 | | | 6 |
| Perfume | | 0.3 | 0.3 | 0.3 | 0.3 | 0.3 | | | 0.7 | | | |
| Sodium lauryl sulphate | | | 2.5 | 2.25 | 3 | | | 3 | 3 | | | |
| Linear alkyl benzene sulphonic acid | | 1.5 | | | | 1.5 | 3 | | | 2.5 | | |
| Sodium Octyl sulphate | | | | | | | | | | | 6 | 6 |
| NI surfactant (1) | | | | | | | | | | 1 | | |
| Diclosan (2) | | | | | | | | | 0.07 | | | |
| NaOH | | As needed to bring the pH of the compositions to 2.1-2.3 | | | | | | | | | | |
| Water | | To balance | | | | | | | | | | |
| TEST CONDITIONS AND RESULTS | | | | | | | | | | | | |
| Composition Concentration in treatment (ppm)(3) | | 242 7 | 149 9 | 1542 | 149 9 | 249 9 | 6473 | 6242 | 1238 | 1599 | 1499 | 1499 |
| Acid concentration in treatment (ppm) | | 255 | 162 | 243 | 146 | 199 | 1553 | 999 | 149 | 328 | 89 | 89 |
| Anionic surfactant concentration in treatment (ppm) | | 36.4 | 37.5 | 34.7 | 45 | 37.5 | 194 | 187 | 37.1 | 40 | 90 | 90 |
| Water Hardness in treatment (4) | | 3gp g | 3gp g | 3gpg | 3gp g | 3gp g | AOAC hard | AOAC hard | 3 gpg | 3gpg | 3gpg | AOAC hard |
| Interfering substance (5) | | NO | NO | NO | NO | NO | 5% | 5% | 5% | NO | NO | NO |
| Log reduction Salmonella | 10 mins | 4.27 | 4.36 | 5.39 | 4.21 | 3.41 | NT | NT | 2.81 | NT | 0 | 0 |
| | 30 mins | 6.27 | 5.18 | 6.09 | 4.24 | 3.44 | NT | NT | NT | NT | NT | NT |
| Log reduction S.aureus | 10 mins | NT | NT | NT | NT | NT | 5.13 | NT | NT | 6.8 | NT | NT |
| Log reduction Klebsiella | 10 mins | NT | NT | NT | NT | NT | 6.27 | 6.75 | NT | NT | NT | NT |

(1) 2-ethylhexyl PO5EO6 alkylalkoxylate. Ecosurf EH 6. Dow
(2) Tinosan HP 100. BASF
(3) Products were dosed by V/V, ppm values shown were obtained by multiplying the volume by the density of each product
(4) AOAC hard water as described in ASTM E2274 industry standard method
(5) 5% horse serum
NT- Not Tested

It can be seen by the data presented in Table 1 that fabrics treated according to the method of the present invention with aqueous liquors resulting from diluting compositions A through I and having at least 100 ppm of acidifying agent and an anionic surfactant show very high bacteriostatic efficacy, between log2.8 and log6.8, while fabrics treated with aqueous liquors resulting from diluting comparative compositions C1, C2 and C3 which provide less than 100 ppm of acidifying agent do not show any measurable bacteriostatic efficacy.

### Example 2

### Fabric Preparation/Pre-Treat

Cotton fabric swatches were scoured cut in squares of 3.8 cm X 3.8 cm and sterilized as described in the Standard Test Method for the Evaluation of Laundry Sanitizers and Disinfectants ASTM E2274. For each test leg, four test swatches weighing approximately 1 g were placed inside a sterile 50 ml centrifuge tube and 18 ml solution of each test sample were added to the fabric containing centrifuge tubes.

The solutions of each test sample were prepared by adding 142.8 µL of the compositions shown in TABLE 2 below to 100 ml of water of 3 gpg hardness. The tubes were placed in a Stuart Rotator and agitated at 40 rpm for 10 minutes. Reference fabrics treated with 3 gpg water were prepared in an identical manner. Water of 3 gpg hardness was prepared by dissolving 56.79 g of CaCl₂ 2H₂O and 26.13 g MgC1₂6H₂0 in 1 L of deionized water and further diluting 0.5 ml of this solution in 1 L of deionize water.

Treated test fabrics were transferred with a sterile tweezer to a sterile 250 ml glass jar and were allowed to dry for 2 hours with the lid ajar before being inoculated with bacteria to evaluate their bacteriostatic efficacy.

### Determination of the Bacteriostatic Efficacy

The ability of the treated fabrics to prevent bacteria multiplication was evaluated according to the industry standard method AATCC100 for the determination of antibacterial efficacy of textile materials.

Table 2

COMPOSITIONS TESTED

| | | | | | | | | |
|---|---|---|---|---|---|---|---|---|
| Ingredients (% weight active) | | J | K | L | M | N | 0 | P |
| Acetic acid | | 0.75 | 0.75 | 0.75 | 0.75 | 0.75 | 0.75 | 0.75 |
| Formic acid | | 1.5 | 0.34 | 0.68 | 1 | 0.1 | 3 | 3 |
| Citric acid | | 9 | 10.2 | 9.82 | 9.5 | 12 | 9 | 6 |
| Perfume | | 0.6 | 0.6 | 0.6 | 0.6 | 0.6 | 0.6 | 0.6 |
| Linear alkyl benzenesulphonic acid | | 3 | 3 | 3 | 3 | 3 | 3 | 3 |
| Nl surfactant (1) | | 1.6 | 1.6 | 1.6 | 1.6 | 1.6 | 1.6 | 1.6 |
| pH (adjusted with NaOH) | | 2.10 | 2.12 | 2.11 | 2.16 | 2.12 | 2.10 | 2.10 |
| Water | | To 100 | To 100 | To 100 | To 100 | To 100 | To 100 | To 100 |
| | pH in the rinse | 3.06 | 3.34 | 3.36 | 3.34 | 3.04 | 3.11 | 3.03 |
| | Log Reduction Salmonella enterica ATCC 10708 | 5.5 | 2.1 | 2.0 | 2.2 | 2.1 | 5.4 | 2.8 |

(1) C12-C14 E07-9 alcohol alkoxylate

It can be seen by the data presented in Table 2 that fabrics treated according to the method of the present invention with aqueous liquors resulting from diluting compositions J through P and having at least 100 ppm of acidifying agent and an anionic surfactant show bacteriostatic efficacy -at least log2 reduction on Salmonella enterica- measured according to the industry standard method AATCC100. Fabric treated with compositions containing more than 1% formic acid show the highest bacteriostatic efficacy-up to log 5.5 reduction. Preferable the citric acid to formic acid ratio is 150 to 5, more preferably 100 to 2 and even more preferably 50 to 3.

Tables 3, 4 and 5 show compositions suitable for use in the method of the present invention

Table 3

LIQUID COMPOSITIONS

| | | | | | | | | |
|---|---|---|---|---|---|---|---|---|
| Ingredients | 1 | 2 | 3 | 4 | 5 | 6 | 7 | 8 |
| Octanoic acid | 4% | | | 8% | | | | |
| Formic acid | 0.2% | 0.1% | 0.5% | | | 1.0% | | 0.1% |
| Acetic acid | 0.1% | 0.75% | | | 1% | 0.75% | | |
| Citric acid | | 12% | 20% | | 10% | 9% | 15% | 12% |
| Lactic acid | 5% | | | | 10% | | | |
| Salicylic acid | | | 5% | 4% | 2% | | | 1% |
| Sodium lauryl sulphate | | | 3% | | | | | |
| Alkyl benzenesulfonic acid | | 3% | | 3% | | 2% | 3% | 2% |
| Alkyl benzene sulphonate | 2% | | | | 1.5% | 1.6% | | |
| NI surfactant (1) | 1.5% | 1.6% | 2% | | | | 1.5% | |
| NI surfactant (2) | | | | 0.5% | 2.5% | | | 1.5% |
| Diclosan | | | | | | | 0.05% | 0.07% |
| Sodium cumene sulphonate | 0.5% | | | 1% | | | | |
| Suds suppressor | 0.5% | | 0.3% | | 0.2% | | | |
| Soil release polymer (3) | 1% | | 2% | | | | | |
| Dye | | 0.0005% | 0.001% | 0.0003% | | 0.00086% | 0.0004% | |
| Perfume | 0.8% | 0.6% | 0.5% | 1% | | 0.6% | 1% | 0.4% |
| pH adjusting agents | As needed to bring pH of composition from about 2 to about 3 | | | | | | | |
| Water and minors | To balance | | | | | | | |

(1) C12-C14 E07-9 alcohol alkoxylate
(2) 2-ethylhexyl POEO alkylalkoxylate. Ecosurf EH 9. Dow
(3) Repel-o-tex or Texcare polymers

Table 4

SPRAY COMPOSITIONS

| | | | | | | | | |
|---|---|---|---|---|---|---|---|---|
| Ingredients | 9 | 10 | 11 | 12 | 13 | 14 | 15 | 16 |
| Formic acid | | | 0.5% | 0.1% | | 0.2% | 0.05% | |
| Citric acid | 0.7% | | | 0.4% | 0.25% | | | |
| Succinic acid | | 0.7% | | | | 0.3% | | 0.2% |
| Salicylic acid | | | | | | | 0.1% | 0.2% |
| Alkyl benzenesulfonic acid | | 0.01% | 0.02% | | 0.05% | | 0.1% | |
| Alkyl benzene sulphonate | 0.05% | | | 0.05% | | 0.1% | | 0.04% |
| Wetting agent (4) | 0.05% | 0.1% | 0.1% | 0.02% | | | 0.1% | 0.09% |
| Hydrogenated castor oil | 0.2% | 0.1% | | | 0.2% | | 0.15% | |
| Diethylene glycol | 0.5% | 0.3% | 0.5% | 0.4% | 0.2% | 0.5% | 0.4% | 0.5% |
| Perfume | 0.8% | 1% | 0.7% | 0.6% | 0.5% | 0.9% | 1% | 0.8% |
| pH adjusting agents | As needed to bring pH of composition from about 2 to about 3.5 | | | | | | | |
| Water and minors | To balance | | | | | | | |

(4) Organo silicone surfactant such as Silwet surfactants. Momentive

Table 5

POWDER COMPOSITIONS

| | | | | | |
|---|---|---|---|---|---|
| Ingredients (% weight active) | 17 | 18 | 19 | 20 | 21 |
| Citric acid | 50% | 35% | 40% | 30% | 60% |
| Sorbic acid | | | 5% | | |
| Salicylic acid | | | | 5% | |
| Alkyl benzene sulphonate | | 3% | | 2.5% | 2% |
| Sodium lauryl sulphate | 2% | | 5% | | |
| Chelant | 0.6% | 0.5% | 0.7% | 0.65% | 0.55% |
| Sulphate | 42% | 56.8% | 48.4% | 58.35% | 34.2 |
| Zeolite | 5% | 4% | 5% | 3% | 3% |
| Perfume | 0.4% | 0.7% | 0.9% | 0.5% | 0.25% |

"The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of treating a fabric, comprising the treatment step of subjecting the fabric to an aqueous liquor comprising an anionic surfactant and from about 100 ppm to about 7,000 ppm of an acidifying agent wherein the treatment step is not followed by a rinse off step.

2. A method according to claim 1 wherein the treatment step involves:
i) total immersion of the fabric in the aqueous liquor; or
ii) spraying the fabric with the aqueous liquor.

3. A method according to claim 1 wherein the treatment step involves total immersion of the fabric in the aqueous liquor and the treatment step takes place in the final rinse cycle of a washing machine.

4. A method according to claim 1 wherein the aqueous liquor has a pH of less than 4.5 as measured at 25° C.

5. A method according to claim 1 wherein the aqueous liquor has a pH between 1.5 and 3.8 as measured at 25° C.

6. A method according to claim 1 wherein the anionic surfactant is selected from the group consisting of alkyl sulphate, alkyl ethoxy sulphate, alkyl benzene sulphonate, alkyl benzene sulphonic acid and mixtures thereof.

7. A method according to claim 1 wherein the acidifying agent comprises an organic acid comprising formic acid, citric acid, lactic acid, succinic acid, sorbic acid, acetic acid, salicylic acid, octanoic acid, malic acid, glycolic acid, itaconic acid, benzoic acid, or a combination thereof.

8. A method according to claim 1 wherein the acidifying agent comprises citric acid and formic acid.

9. A method according to claim 1 wherein the aqueous liquor comprises at least 10 ppm of anionic surfactant.

10. A method according to claim 1 wherein the aqueous liquor comprises from about 15 ppm to about 1,000 ppm of anionic surfactant.

11. A method according to claim 1 wherein the weight ratio of acidifying agent to anionic surfactant in the aqueous liquor is from about 800:1 to about 0.5:1.

12. A method according to claim 1 wherein the weight ratio of acidifying agent to anionic surfactant in the aqueous liquor is from about 600:1 to about 1:1.

13. A method according to claim 1 wherein the aqueous liquor comprises one or more additional ingredients selected from the group consisting of additional surfactants, hydrotropes, wetting agents, dyes, additional antimicrobial actives, suds suppressors, solvents, complexing agents, soil release polymers, viscosity control agents, structurants, perfumes, pH adjusting agents, optical brighteners, encapsulated actives, and mixtures thereof.

14. A method according to claim 1 wherein the aqueous liquor comprises an additional surfactant comprising a non-ionic surfactant.

15. A method according to claim 1 wherein the aqueous liquor comprises an additional surfactant comprising a non-ionic surfactant wherein the non-ionic surfactant comprises an alcohol ethoxylate surfactant.

16. A method according to claim 1 wherein the aqueous liquor is formed by diluting or dissolving a composition in water to a concentration between 0.01 and 99.5 % of the initial concentration of the composition prior to treating the fabric.

17. A method according to claim 1 wherein the composition is in liquid form and comprises:
a) from about 0.05 to about 4.5% by weight of the composition of an anionic surfactant, selected from the group consisting of alkyl sulphate, alkyl ethoxy sulphate, alkyl benzene sulphonate, alkyl benzene sulphonic acid and mixtures thereof; and
b) from about 8 to about 35% by weight of the composition of an acidifying agent selected from the group consisting of: formic acid, citric acid, lactic acid, succinic acid, sorbic acid, acetic acid, salicylic acid, octanoic acid, malic acid, glycolic acid, benzoic acid, itaconic acid, and mixtures thereof; and
c) optionally from about 0.5 to about 3% by weight of the composition of an additional surfactant.

18. A method according to claim 1 wherein the composition is in solid form and comprises:
a) from about 1 to about 10% by weight of the composition of an anionic surfactant, selected from the group consisting of alkyl sulphate, alkyl ethoxy sulphate, alkyl benzene sulphonate, alkyl benzene sulphonic acid and mixtures thereof; and
b) from about 8 to about 70% by weight of the composition, of an acidifying agent selected from the group consisting of: formic acid, citric acid, lactic acid, succinic acid, sorbic acid, acetic acid, salicylic acid, octanoic acid, malic acid, glycolic acid, itaconic acid, benzoic acid and mixtures thereof.

19. A method according to claim 1 wherein the composition is in the form of a ready-to-use spray and comprises:
a) from about 0.001% to about 0.1% by weight of the composition of an anionic surfactant selected from the group consisting of alkyl sulphate, alkyl ethoxy sulphate, alkyl benzene sulphonate, alkyl benzene sulphonic acid and mixtures thereof; and
b) from about 0.015% to about 0.7% by weight of the composition, of an acidifying agent selected from the group consisting of formic acid, citric acid, lactic acid, succinic acid, sorbic acid, acetic acid, salicylic acid, octanoic acid, malic acid, glycolic acid, benzoic acid, itaconic acid and mixtures thereof.
